(19) United States
(12) Patent Application Publication
(10) Pub. No.: US 2004/0022494 A1
(43) Pub. Date: Feb. 5, 2004

(54) Fiber optic array with fiber tap and methd for making and using

(76) Inventors: James A. Liddle, Walnut Creek, CA (US); Stuart T. Stanton, Bridgewater, NJ (US); Kurt S. Werder, Stirling, NJ (US)

Correspondence Address: DICKSTEIN SHAPIRO MORIN & OSHINSKY LLP, 2101 L STREET NW, WASHINGTON, DC, 20037-1526, US

(21) Appl. No.: 10/211,310

(22) Filed: Aug. 5, 2002

(51) Int. Cl. G02B 6/26

(52) U.S. Cl. 385/48; 216/24

(57) ABSTRACT

A fiber tap with configurable wavelength and polarization sensitivities and which may include a fiber connector is described. In one embodiment, light reflected from an interface between a pair of fibers is reflected into a photodetector with the option of an intermediate light pipe. In another embodiment, light reflected from an interface between a pair of fiber sections is reflected into an etched opening. The opening is filled with an index matching material and includes a mirrored surface. The reflected light is directed from the mirrored surface to a photodetector. In each embodiment, an assembly technique for tapping arrays of several fibers is supported.

### BACKGROUND

The present invention generally relates to fiber optic arrays, and more particularly to such arrays having integrated fiber taps.

Generally, optical fiber arrays include a plurality of fiber optic systems. Taps are common elements in fiber optic systems. Tapping a portion of an optical signal, generally about one percent (1%), before and/or after an optical device, is necessary to measure what effect an optical device has on the signal. For example, optical power may be measured to confirm an attenuation level to enable closed-loop control of the optical device. Specifically, a first tap may be placed upstream of an optical device to determine the power of a signal entering the device and a second tap may be placed downstream of the device to determine the power of the signal leaving the device. The difference in the two determined powers indicates the effect of the optical device on the signal power. Closed-loop control of optical devices is a requirement for many telecommunication devices. Conventional taps utilize fused “Y” junctions, grating or resonant tunneling to obtain a portion of the optical signal. An example of a conventional tap used in fiber optic systems is described in U.S. Pat. No. 6,249,626 (Bergmann), in which a portion of a signal transmitted through a gradient index lens is reflected back into a multimode fiber to an optical power monitor, or tap. In general, some conventional taps are bulky (especially if combined to form an array), usually require fiber splices, are expensive, require extensive handling, and are typically sensitive to polarization of the incident light. Thus, the use of conventional taps raises system costs.

In addition to taps, fiber connectors are generally utilized in fiber optic systems. Generally, optical fibers are optically coupled through the use of fiber connectors by having optical fibers connect to one another at ends which are transverse to the longitudinal axis of the fibers and coplanar to one another. When the ends of the fibers contact each other, input light is transmitted from one optical fiber to the other with little or no transmission loss. When there is a gap between the optical fibers, a boundary is created due to the difference in the indices of refraction between the optical fibers and the gap. When light is incident on a boundary between low and high refractive index media, a fraction of the light is reflected. The difference in the indices of refraction causes a portion of the input light to be reflected at the gap or interface between the two optical fibers. For a glass/air interface, such as is found at a suitably sized gap between optical fibers, the amount of reflection is about four percent (4%). A suitably sized gap or interface includes gaps or interfaces which allow a certain amount of acceptable reflection (signal loss) and which allow a certain amount of acceptable polarization sensitivity. The determination of what is “acceptable” signal loss and “acceptable” polarization sensitivity depends on the requirements of the system, and such determination is well within the abilities of one of ordinary skill in the art.

It is undesirable for reflected light to travel back along the optical fiber from the interface (180 degrees from the direction of the original light transmission). Reflection of light having only one one-hundred thousandths (1/100,000) the strength of the originally transmitted light in the direction opposite from the originally transmitted light may be sufficient to cause a deleterious effect on the system. Hence, the ends of the optical fibers are generally polished on an angle to prevent reflected light from retracing the route of the originally transmitted light. Typically, optical fiber ends are polished at an angle of about eight degrees (8°). When light reflects at the glass/air interface of such an angle polished fiber, a portion of the light reflects at an angle at about sixteen degrees (16°) to the fiber core. At such a steep angle, the reflected light is no longer confined to the optical fiber core and is quickly dissipated through the cladding of the fiber.

In conventional fiber optic systems, polarization of light in a fiber varies in a random manner. As such, using conventional taps to detect a signal prior to and after an optical device may result in changes in apparent signal intensity because of the polarization sensitivity of the tap.

There exists a need in the industry to manufacture in a cost effective manner taps for fiber optic systems, particularly in an arrayed form. There further exists a need for the manufacture of taps that are polarization insensitive.

### SUMMARY

The invention provides a fiber optic tap that includes at least first and second fibers, the fibers adapted to carry a signal, an interface between the first and second fibers configured to direct a portion of the signal out of the fibers, and a photodetector for detecting the portion of the signal directed out of the fibers. The invention further provides an array of fibers having at least one such tap.

The invention also provides a method for making a fiber optic tap or array of taps. The method includes the steps of positioning at least one fiber in a first substrate, wherein the fiber is adapted to carry a signal, cutting the fiber into a first fiber section and a second fiber section, configuring an interface between the first and second fiber sections to enable a portion of the signal to be directed out of the fiber sections, and providing a photodetector at a location where it can receive the portion of the signal to be directed out of the fiber sections.

The foregoing and other advantages and features of the invention will be more readily understood from the following detailed description of the invention, which is provided in connection with the accompanying drawings.

### BRIEF DESCRIPTION OF THE DRAWINGS

FIGS. 1A and 1B are cross-sectional views of an integrated optical fiber tap in opened and closed positions and constructed in accordance with a first embodiment of the invention.

FIG. 2 is a top view of an integrated optical fiber tap connector constructed in accordance with a second embodiment of the invention.

FIG. 3 is a cross-sectional view taken along line III-III of FIG. 2.

FIG. 4 is a cross-sectional view taken along line IV-IV of FIG. 2.

FIG. 5 illustrates a method for making an integrated optical fiber tap in accordance with the second embodiment of the invention.

FIG. 6 illustrates a method for using an integrated optical fiber tap in accordance with the first and second embodiments of the invention.

### DETAILED DESCRIPTION OF PREFERRED EMBODIMENTS

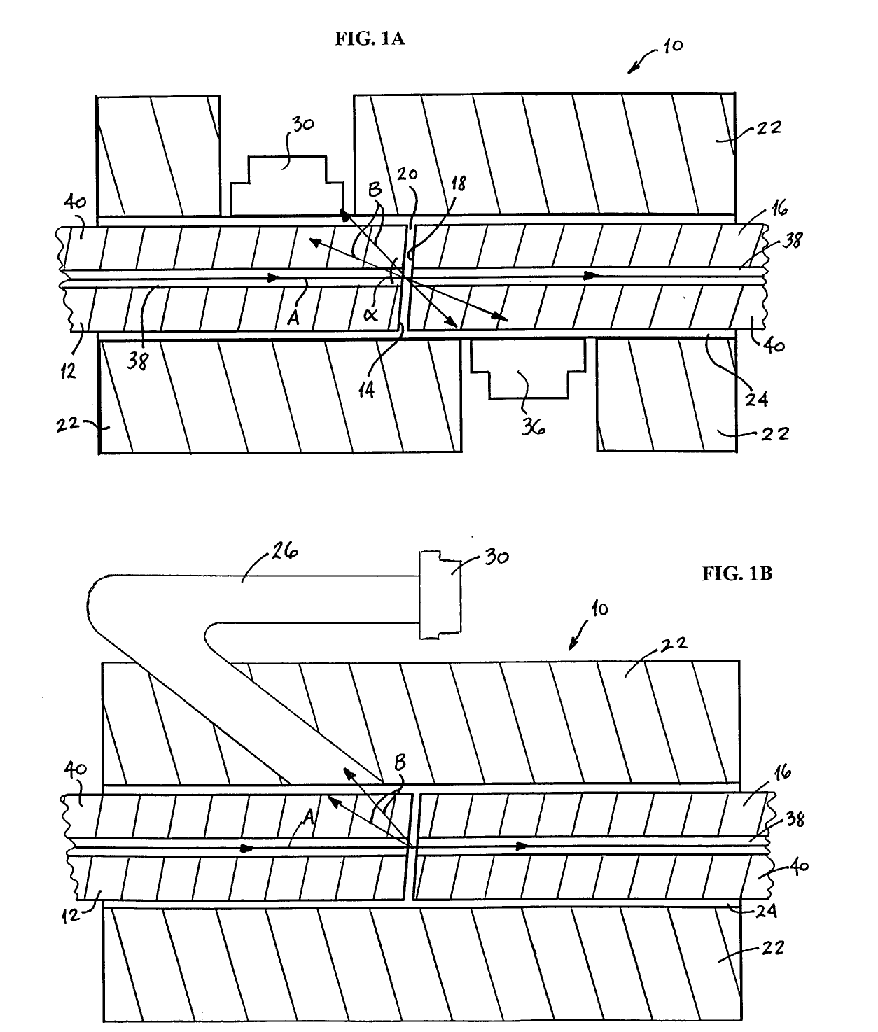

Referring to FIGS. 1A and 1B, in which like numerals designate like elements, a fiber tap 10 in a first embodiment of the invention is shown including a first fiber 12 and a second fiber 16 mounted within and extending through an opening 24 of a support member 22. The first fiber 12 has an end 14 that opposes an end 18 of the second fiber 16. The fibers 12, 16 each includes a fiber core 38 surrounded by a cladding 40.

A gap 20 separates the fiber ends 14, 18 when the fiber connectors 12, 16 are in an opened position (FIG. 1A). It should be appreciated that the size of the gap is important. If the gap is too small, the light signal fails to recognize a gap and no reflection of the signal occurs. If the gap is too large, the light signal spreads out too much, leading to high losses of light. The gap should be within the range of larger than the wavelength of the light being transmitted and smaller than ten times the size of the wavelength of the light being transmitted. To set the gap within the correct range, a fine wire may be placed between the fiber ends 14, 18.

In the opened position, the fiber tap 10 is able to function in that the gap 20 allows for a certain amount of reflected light to be tapped from an original signal A being transmitted from the first fiber 12 to the second fiber 16. Each of the fibers 12, 16 are movable relative to one another and can be moved into a closed position. In the closed position, the fiber tap 10 cannot function, as the absence of an index of refraction differential suppresses the reflection of any of the signal A.

The originally transmitted light signal A is sent through the fiber core 38. At the gap 20 between the ends 14, 18 (FIG. 1A), a portion B of the signal A is reflected from the interface. The angle of the end 14 provides a suitable reflection angle, which may be, for example, sixteen degrees (16°). The portion B of light fails to be confined in the fiber core and diverges as it travels toward the cladding 40. An index matching material with an index of refraction suitably close to that of the cladding 40 of the first fiber 12 is used to avoid confinement by the cladding 40. A suitably close index of refraction is such that an acceptable amount of signal is reflected and an acceptable sensitivity to light polarization occurs, where “acceptable” is determined by the requirements of the fiber optic system. The portion B is then directed to a detector array 30, which may be index-matched to extract a light signal.

The above-described fiber tap 10 presumes that the originally transmitted signal A is transmitted as shown, from the first fiber 12 to the second fiber 16. For an originally transmitted signal A which is transmitted from the second fiber 16 to the first fiber 12, the reflected portion B is reflected to a second detector array 36. One embodiment may also utilize a length of multi-mode fiber as a light pipe to carry the tapped diverging light out to a remote detector.

In an alternative embodiment (FIG. 1B), the reflected and diverging light may be received by a light pipe 26 which is in communication with a detector array 30.

As noted above, optical fibers are connected together by way of fiber connectors. It should be appreciated that the fiber tap 10 may be incorporated into a fiber connector. The fiber tap 10 shown in FIGS. 1A and B, may also include an integrally formed fiber connector which combines the functionality of both a fiber connector and a tap to provide a cost effective approach to tapping the portion B of the transmitted signal A. Such a fiber tap 10 is insensitive to the wavelength of the transmitted signal A, produces a low loss such that it does not significantly reduce the fraction of light transmitted through the system, provides good collection efficiency, is capable of controlling the amount of light tapped, and is relatively insensitive to light polarization. In addition, the illustrated fiber tap 10 improves fiber management and shrinks the cost and footprint of fiber optic systems utilizing it.

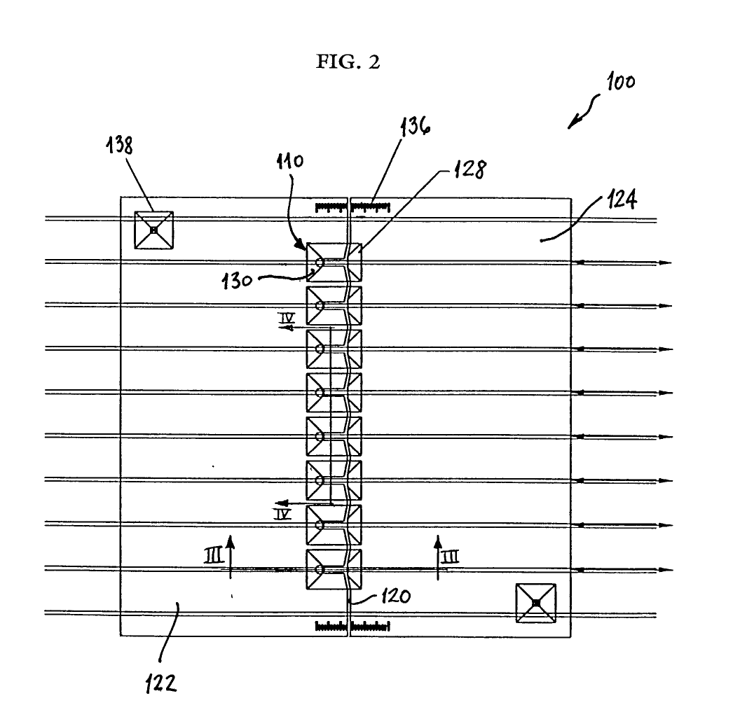

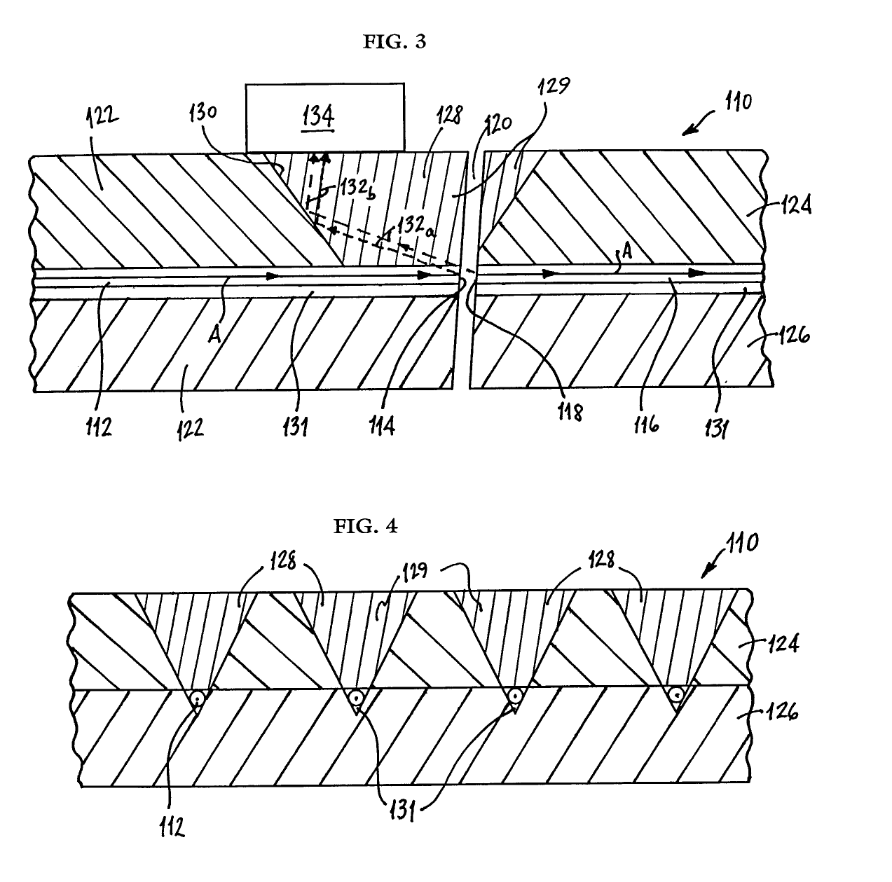

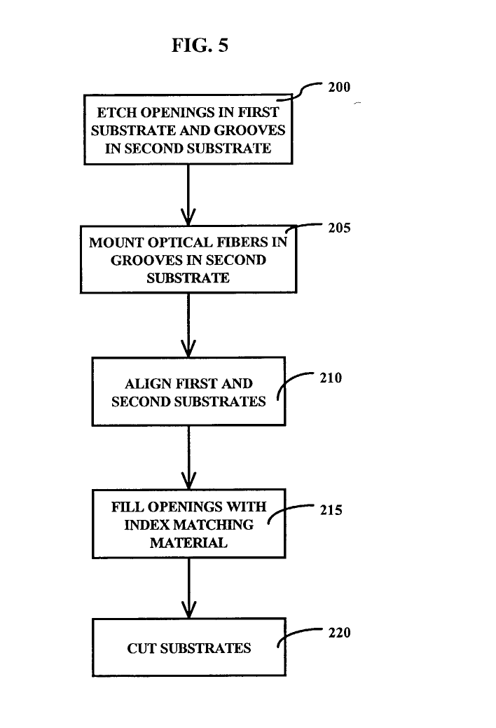

FIGS. 2-4 illustrate a fiber optic array 100 which includes a plurality of fiber taps 110 constructed in accordance with a second embodiment of the invention. Alternatively, the array 100 may include a plurality of fiber taps 10 (FIGS. 1A and 1B) or a combination of fiber taps 10 and 110. The illustrated array 100 has a support member 122 including a first substrate 124 and a second substrate 126 (FIGS. 3-4). A plurality of V-grooves 131 extends through an upper surface of the second substrate 126. Further, a plurality of rhomboid openings 128 is formed in the first substrate 124. The V-grooves 131 and the rhomboid openings 128 are preferably anisotropically etched. When the first and second substrates 124, 126 are properly aligned, the openings 128 each extend toward and are coextensive with a portion of respective V-grooves 131 formed in the second substrate 126.

Each opening 128 includes a wall having a mirrored surface 130 which serves as a reflection surface for a portion of a transmitted signal (to be described in greater detail below). Additionally, each opening 128 is filled with an index matching material 129. The index matching material 129 is a material with an index of refraction suitably matched to the index of refraction of the fiber cladding surrounding the fiber core of the optical fiber extending through the V-grooves 131. As noted above, a suitably matched index of refraction is such that an acceptable amount of signal is reflected and an acceptable sensitivity to light polarization occurs, where “acceptable” is determined by the requirements of the fiber optic system. As illustrated in FIGS. 3-4, optical fibers formed of first and second fiber sections 112 and 116 are mounted within the channels 131. The first fiber sections 112 include ends 114 that oppose ends 118 of the second fiber sections 116. As illustrated in FIG. 3, the fiber sections 112, 116 are separated by a gap or interface 120.

As an originally transmitted signal A is sent from the first fiber section 112 to the second fiber section 116, a portion 132a of the signal is reflected at the interface 120 due to the change in the index of refraction at that boundary. The reflected portion 132a is directed into the openings 128 through the index matching material 129 toward the mirrored surface 130. As noted above, the index matching material 129 is preferably suitably matched to the index of the cladding material surrounding the fiber core of the fiber sections 112 and 116. The portion 132a is then reflected off of the mirrored surface 130. The twice reflected signal portion 132b is directed into a detector 134. The change in angle of the emerging light due to this reflector makes mode-matching to the detector unecessary. Preferably, the detector 134 is a p-type/intrinsic/n-type (PIN) photodiode.

The optical fiber array 100, which includes a plurality of fiber taps 110 as described above, may also include integrally formed fiber connectors. When initially assembled, the substrates 124, 126 are each in one piece. A saw is used to cut the substrates 124, 126 and the fiber sections 112, 116, thereby forming the gap 120. For taps, a simple assembly technique could utilize a saw scale or vernier 136 printed on opposing sides of the substrate 122 and serving to ensure proper positioning of the saw for accurate cutting. Alignment during assembly serves to align the mirrored surface 130 precisely with respect to the fiber sections 112, 116. As illustrated in FIG. 2, a box-in-box alignment assembly 138 is utilized. Anisotropic etching is used to etch a pair of boxes in each of the substrates 124, 126. By matching up the boxes, alignment between the substrates 124, 126 is achieved.

If the tap is used in a repetitive connection operation involving different assembly halves, a repeatable mechanical alignment reference is needed. These methods are already characteristic of all efficient fiber coupler schemes, and thus the taps of FIGS. 2-4 can be integrated into any fiber connector type, for example, LC, ST, FC, MTP, MPX, etc. Thus, one skilled in the art can incorporate the fiber optic tap of the present invention into a fiber connector.

FIG. 5 illustrates a method for making the fiber taps 110 illustrated in FIGS. 2-4. The method reduces fiber optic system cost, signal loss and integration time. At step 200, openings 128 are anisotropically etched in a first substrate 124 and grooves 131 are anisotropically etched in a second substrate 126. The etching of the rhomboid openings 128 creates mirrored surfaces 130 one a wall in the openings 128. At step 205, optical fibers are immovably mounted within the grooves 131. Then, at step 210 the first and second substrates 124 and 126 are aligned. As schematically shown in FIG. 2, an alignment assembly 138 is used to align the substrates 124 and 126. The openings 128 are then filled with an index matching material 129 at step 215. The substrates 124, 126 and the optical fibers are then cut at step 220 in a location to create the fiber sections 112, 116 which are separated by a gap 120. To ensure a precise cut, saw scales 136 are provided on opposing ends of the first substrate 124 and the saw is aligned on the saw scales.

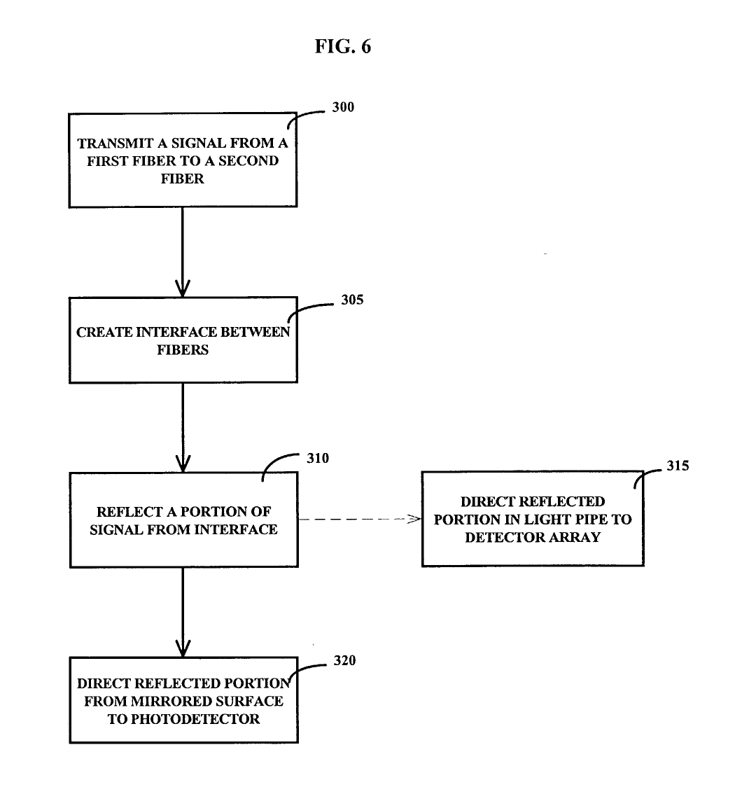

Next, with reference to FIG. 6 will be described a method for using an embodiment of the fiber taps 10, 110 described herein. At step 300, a signal A is transmitted through a first fiber 12 or first fiber section 112 to a second fiber 16 or second fiber section 116. As a preliminary step, a fine wire or other gauge is inserted into the gap 20 to properly set the gap between the fiber ends. At step 305, an interface 20, 120 is created between the fibers or fiber sections (FIGS. 1A, 3). At step 310, a portion B, 132a of the signal A is reflected from the interface 20, 120. At step 315, for the fiber tap 10 illustrated in FIGS. 1A and 1B, the portion B is re-reflected in a light pipe 26. Alternatively, for the fiber tap 110 illustrated in FIGS. 2-4, the portion 132a is directed off of the mirrored surface 130. The directed portion 132b is then directed into a PIN diode 134.

While the invention has been described in detail in connection with the preferred embodiments known at the time, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Further, the fiber taps illustrated in FIGS. 1-4 are described as being relatively polarization insensitive, and their characteristics are preferably good over some spectral width of use. It is to be appreciated that the invention described in terms of fiber facet reflections can be adjusted by the use of coatings on one or both facets. Also, the ends of the fibers can be polished at a different angle to reduce or increase polarization sensitivity or modify the tapping geometry. Coating on the fiber ends may be designed to suppress etalon effects over a wide spectrum which allows the size of the gap between the fibers to be approximated, thereby reducing the assembly cost. Coatings may also provide desired wavelength dependence features. In addition, a coating or the angle of the mirrored surface 130 or the mirror or prism may be altered to affect polarization sensitivity, including to provide polarization selection. Finally, the index matching material 129 may be altered to become somewhat index mismatching in order to affect polarization sensitivity. Accordingly, the invention is not to be seen as limited by the foregoing description, but is only limited by the scope of the appended claims.

What is claimed as new and desired to be protected by Letters Patent of the United States is:

1. A fiber optic tap, comprising:
at least one pair of first and second fibers, said fibers adapted to carry a signal;
an interface between said first and second fibers configured to direct a portion of the signal out of said fibers; and
a photodetector for detecting the portion of the signal directed out of said fibers.

2. The fiber optic tap of claim 1, further comprising a light pipe for directing the portion of the signal directed out of said fibers to said photodetector.

3. The fiber optic tap of claim 1, further comprising a mirror for directing the portion of the signal directed out of said fibers to said photodetector.

4. The fiber optic tap of claim 1, wherein the portion of the signal directed out of said fibers is polarization insensitive.

5. A fiber optic array, comprising:
a plurality of pairs of first and second fibers, said fibers adapted to carry a signal;
an interface between said first and second fibers configured to direct a portion of the signal out of said fibers; and
at least one photodetector for detecting the portion of the signal directed out of said fibers.

6. The fiber optic array of claim 5, further comprising a support member including a first substrate positioned on a second substrate, wherein said first and second fibers are mounted on said second substrate.

7. The fiber optic array of claim 6, wherein said second substrate comprises at least one groove, said first and second fibers being mounted in said groove.

8. The fiber optic array of claim 7, wherein said first substrate comprises at least one opening extending down to said groove.

9. The fiber optic array of claim 8, wherein said opening comprises a wall having a mirrored surface for reflecting the portion of the signal directed out of said fibers to said photodetector.

10. The fiber optic array of claim 9, further comprising an index matching material within said opening, wherein the reflected portion of the signal directed out of said fiber is directed through said index matching material and is reflected off of the mirrored surface to said photodetector.

11. The fiber optic array of claim 10, wherein said photodetector comprises a PIN diode.

12. The fiber optic array of claim 6, further comprising an alignment assembly for aligning said first substrate relative to said second substrate.

13. The fiber optic array of claim 6, further comprising a pair of saw scales on opposing sides of said first substrate.

14. A method for making a fiber optic array, comprising:
positioning at least one fiber in a first substrate, wherein the fiber is adapted to carry a signal;
cutting the fiber into a first fiber section and a second fiber section;
configuring an interface between the first and second fiber sections to enable a portion of the signal to be directed out of the fiber sections; and
providing a photodetector at a location where it can receive the portion of the signal to be directed out of the fiber sections.

15. The method of claim 14, wherein said positioning at least one fiber in a first substrate comprises etching a groove in the first substrate and positioning the fiber in the groove.

16. The method of claim 15, wherein said providing a photodetector at a location where it can receive the portion of the signal to be directed out of the fiber sections comprises:
etching an opening in a second substrate;
placing the second substrate over the first substrate; and
positioning the photodetector at least partially over the opening, wherein the portion of the signal to be directed out of the fiber sections is directed through the opening to the photodetector.

17. The method of claim 16, wherein said cutting of the fiber includes cutting the first and second substrates.

18. The method of claim 17, further comprising aligning the first and second substrates relative to one another prior to said cutting.

19. The method of claim 16, wherein said etching an opening comprises anisotropically etching the opening.

20. The method of claim 16, further comprising filling the opening with an index matching material.
